(19) United States
(12) Patent Application Publication
(10) Pub. No.: US 2026/0185475 A1
(43) Pub. Date: Jul. 2, 2026

(54) PRESSURE DIFFERENCE DETECTION DEVICE FOR PARTICULATE COLLECTION FILTER

(71) Applicant: TOYOTA JIDOSHA KABUSHIKI KAISHA, Toyota-shi (JP)

(72) Inventors: Kazumasa KATOH, Misima-shi (JP); Yukihiro NAKASAKA, Nagaizumi-cyou (JP)

(73) Assignee: TOYOTA JIDOSHA KABUSHIKI KAISHA, Toyota-shi (JP)

(21) Appl. No.: 19/415,191

(22) Filed: Dec. 10, 2025

(30) Foreign Application Priority Data
Dec. 26, 2024 (JP) 2024-230842

(51) Int. Cl. F01N 11/00; B01D 46/00; G01L 13/00

(52) U.S. Cl. CPC F01N 11/002; B01D 46/0086; G01L 13/00; F01N 2900/1406

(57) ABSTRACT

A pressure difference detection device, for a particulate collection filter, includes an upstream pressure sensor, a downstream pressure sensor, an air flow meter, a low-pass filter, a processed differential pressure value acquiring unit, an intake air amount correcting unit, and an actual differential pressure value acquiring unit.

### CROSS-REFERENCE TO RELATED APPLICATION

This application is based upon and claims the benefit of priority of the prior Japanese Patent Application No. 2024-230842, filed on December 26, 2024, the entire contents of which are incorporated herein by reference.

### TECHNICAL FIELD

The present disclosure relates to a pressure difference detection device for a particulate collection filter.

### BACKGROUND

Conventionally, it has been proposed to detect a differential pressure between the front and rear of a particulate collection filter provided in an exhaust path of an internal combustion engine (for example, see WO 2023/233605). The differential pressure between the front and the rear of the particulate collection filter is used for control of regeneration processing of the particulate collection filter or used for abnormality determination of the particulate collection filter itself. Therefore, it is required to detect the differential pressure between the front and rear of the particulate collection filter as accurately as possible. Here, when the upstream pressure and the downstream pressure of the particulate collection filter are compared, a phase difference caused by a difference in detection position appears in the pressure waveforms. In WO 2023/233605, in order to reduce the influence of the phase difference, the upstream pressure and the downstream pressure with respect to the particulate collection filter are corrected based on the engine speed and other information.

Incidentally, expensive noble metals are used for the particulate collection filter, and various countermeasures against theft thereof have been proposed. However, it is assumed that the vehicle is operated with the particulate collection filter removed, regardless of whether or not such a theft countermeasure is taken. The phase difference of the pressure waveform in the particulate collection filter is different between a state where the particulate collection filter is mounted and a state where the particulate collection filter is removed. Therefore, even if the phase difference is corrected as proposed in WO 2023/233605, it is difficult to accurately detect the differential pressure between the upstream and downstream sides in both of the state where the particulate collection filter is mounted and the state where the particulate collection filter is removed.

Further, exhaust pulsation corresponding to the number of cylinders of the internal combustion engine appears in the pressure waveform of the exhaust. The cycle of the exhaust pulsation changes according to the rotational speed of the internal combustion engine. Therefore, the calculation cycle of the differential pressure across the particulate collection filter may coincide with the cycle of the exhaust pulsation. When the calculation cycle of the differential pressure across the particulate collection filter and the cycle of the exhaust pulsation coincide with each other, an aliasing phenomenon may occur in which the detected signal is detected as a value different from the actual value. It is known that the aliasing phenomenon has a large influence when the pulsation amplitude is large. When the aliasing phenomenon occurs, the differential pressure across the particulate collection filter apparently changes, and an accurate differential pressure value across the particulate collection filter might not be detected. In the proposal of WO 2023/233605, there is a possibility that an accurate detection result might not be acquired due to the aliasing phenomenon.

### SUMMARY

It is therefore an object of the present disclosure to provide a pressure difference detection device, for a particulate collection filter, detecting a pressure difference with high accuracy regardless of a state of the particulate collection filter.

The above object is achieved by a pressure difference detection device, for a particulate collection filter, includes: an upstream pressure sensor that is disposed on an upstream side of the particulate collection filter disposed in an exhaust path connected to an internal combustion engine and detects an upstream pressure of the particulate collection filter; a downstream pressure sensor that is disposed on a downstream side of the particulate collection filter and detects a downstream pressure of the particulate collection filter; an air flow meter that is disposed in an intake path connected to the internal combustion engine and detects an intake air amount; a low-pass filter configured to reduce a high-frequency component included in each of an output signal of the upstream pressure sensor and an output signal of the downstream pressure sensor so as to reduce pulsation amplitude; a processed differential pressure value acquiring unit configured to acquire a processed differential pressure value which is a difference between a processed upstream pressure value and a processed downstream pressure value, the processed upstream pressure value being the output signal of the upstream pressure sensor after passing through the low-pass filter, the processed downstream pressure value being the output signal of the downstream pressure sensor after passing through the low-pass filter; an intake air amount correcting unit configured to perform a smoothing process on the intake air amount detected by the air flow meter to acquire a corrected intake air amount, such that the corrected intake air amount follows a change rate of the processed differential pressure value in which a response delay is reflected, the response delay being caused by passing the output signal of the upstream pressure sensor and the output signal of the downstream pressure sensor through the low-pass filter are reflected in the change rate; and an actual differential pressure value acquiring unit configured to acquire an actual differential pressure value between an upstream pressure and a downstream pressure of the particulate collection filter based on a correspondence relationship between the processed differential pressure value and the corrected intake air amount.

In the pressure difference detection device for the particulate collection filter having the above configuration, the smoothing process may be performed such that a waveform indicating a change in the intake air amount approaches a waveform of the processed differential pressure value in which the response delay occurs.

In the pressure difference detection device for the particulate collection filter having the above configuration, the intake air amount correcting unit may be configured to perform the smoothing process so as to match the waveform indicating a change in the intake air amount with the waveform of the processed differential pressure value in which the response delay occurs.

In the pressure difference detection device for the particulate collection filter having the above configuration, the output signal of the upstream pressure sensor and the output signal of the downstream pressure sensor may be input to the low-pass filter, and the low-pass filter may be configured to reduce high-frequency components respectively included in the output signal of the upstream pressure sensor and the output signal of the downstream pressure sensor so as to reduce the pulsation amplitude.

In the pressure difference detection device for the particulate collection filter having the above configuration, a difference value between the output signal of the upstream pressure sensor and the output signal of the downstream pressure sensor may be input to the low-pass filter, and the low-pass filter may be configured to reduce a high-frequency component included in the difference value so as to reduce the pulsation amplitude.

### BRIEF DESCRIPTION OF THE DRAWINGS

FIG. 1A is a schematic configuration view of an engine system to which a pressure difference detection device for a particulate collection filter according to an embodiment is applied, and

FIG. 1B is a functional block view of an ECU in a variation;

FIG. 2A is a graph illustrating an example of a raw pressure waveform which is a raw detection value of the upstream pressure of the particulate collection filter and a waveform after the LPF process in which the waveform is passed through the low pass filter,

FIG. 2B illustrates an example of a raw pressure waveform which is an unprocessed detection value of the downstream pressure of the particulate collection filter and a waveform after LPF process in which the raw pressure waveform is passed through a low pass filter, and

FIG. 2C illustrates an example of a raw pressure waveform of the differential pressure across the particulate collection filter calculated based on the raw detection values and a waveform after the LPF process in which the raw pressure waveform is passed through the low pass filter;

FIG. 3A is a graph illustrating a relationship between an intake air amount Ga and the differential pressure across the particulate collection filter before the LPF process and a relationship between the intake air amount Ga and the differential pressure across the particulate collection filter after the LPF process,

FIG. 3B is an enlarged graph illustrating the relationship between the intake air amount Ga and the differential pressure across the particulate collection filter after the LPF process, and

FIG. 3C is a graph illustrating a relationship between a corrected intake air amount Ga after the smoothing process and the differential pressure across the particulate collection filter after the LPF process, and also illustrating thresholds for abnormality determination;

FIG. 4A is an explanatory view illustrating a model for reproducing a response delay that occurs in the upstream and downstream pressures of the particulate collection filter due to the LPF process, and

FIG. 4B is an explanatory view of a model in which the intake air amount is subjected to a smoothing process in correspondence with the response delay occurring in the upstream and downstream pressures of the particulate collection filter;

FIG. 5A is an explanatory view illustrating the model in FIG. 4A, which reproduces the response delay that occurs in the upstream or downstream pressures of the particulate collection filter, overlaid with the model in FIG. 4B in which the intake air amount is subjected to the smoothing process, and

FIG. 5B is an example of a graph illustrating errors of the two models overlaid in FIG. 5A; and

FIG. 6 is an example of a flowchart for determining an abnormality of the particulate collection filter based on the pressure difference detected by the pressure difference detection device for the particulate collection filter according to the present embodiment.

### DETAILED DESCRIPTION

Hereinafter, embodiments of the present disclosure will be described with reference to the accompanying drawings. However, in the drawings, the dimensions, ratios, and the like of the respective parts may not be illustrated so as to completely match the actual ones. In some drawings, details are omitted.

### Embodiment

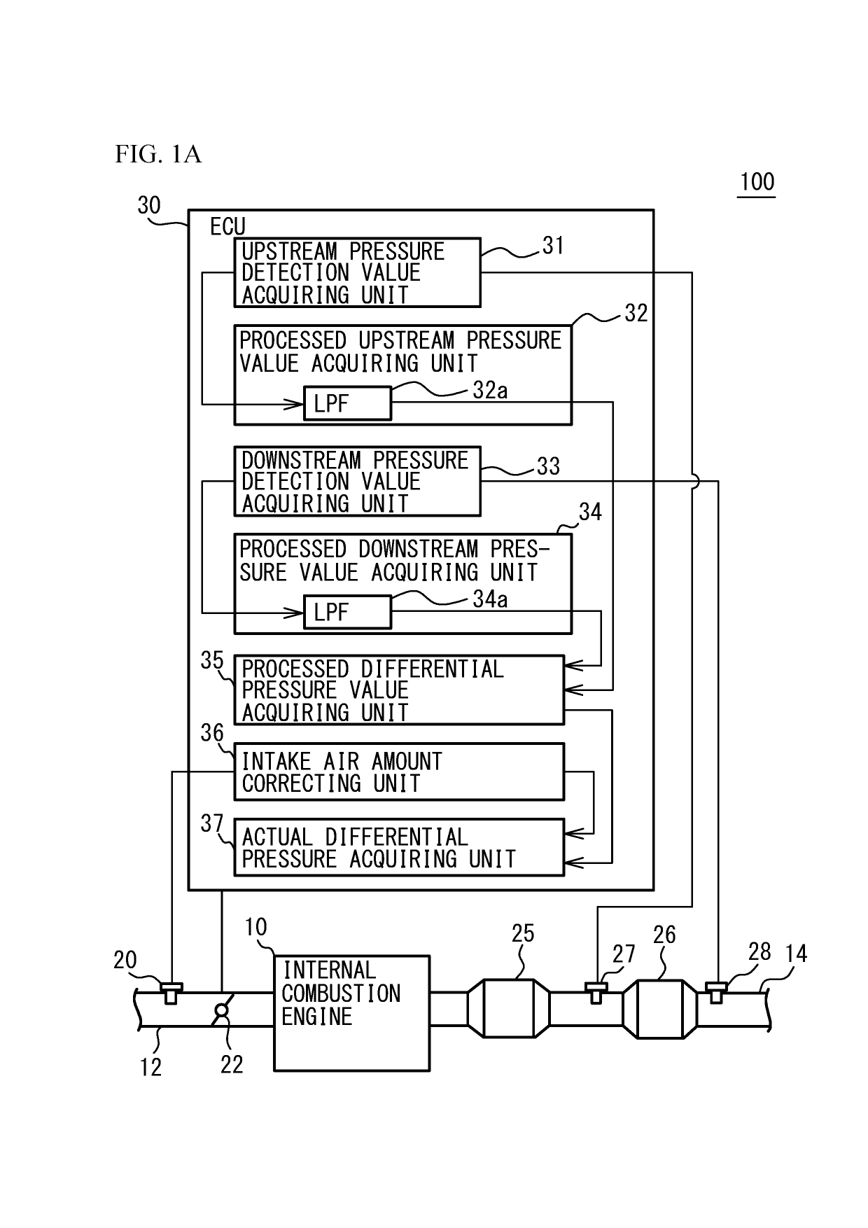

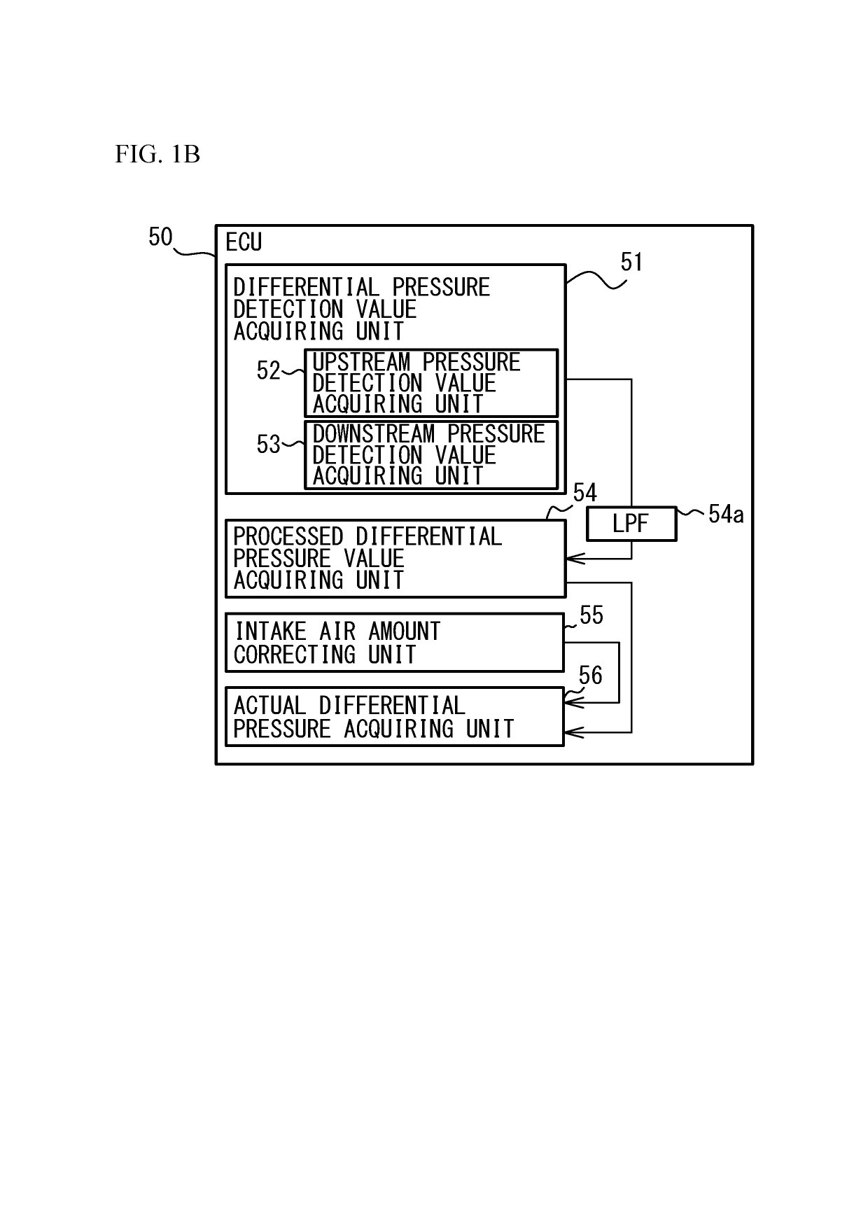

First, a schematic configuration of an engine system 100 to which a pressure difference detection device for a particulate collection filter according to an embodiment is applied will be described with reference to FIG. 1A. The engine system 100 includes an internal combustion engine 10, an intake path 12, an exhaust path 14, and an electronic control unit (ECU) 30. Air flows through the intake path 12 and is introduced into the internal combustion engine 10. The air forms a mixture with the fuel in the combustion chamber of the internal combustion engine 10. The combustion of the air-fuel mixture generates power. Exhaust gas generated by the combustion flows through the exhaust path 14 and is discharged.

The internal combustion engine 10 is a gasoline engine that uses gasoline as fuel. The internal combustion engine 10 may be a diesel engine using light oil as fuel. An air flow meter 20 and a throttle valve 22 are provided in the intake path 12 in this order from the upstream side. The exhaust path 14 is provided with a catalyst 25, an upstream pressure sensor 27, a gasoline particulate collection filter (GPF) 26 as a particulate collection filter, and a downstream pressure sensor 28 in this order from the upstream side.

The air flow meter 20 detects the flow rate of intake air in the intake path 12. The throttle valve 22 adjusts the flow rate of intake air. When the opening degree of the throttle valve 22 increases, the flow rate of the intake air increases. When the opening degree decreases, the intake air amount decreases.

The catalyst 25 is, for example, a three way catalyst. The GPF 26 collects particulate matters in the exhaust gas. When the internal combustion engine 10 is a diesel engine, a diesel particulate collection filter (DPF) is provided instead of the GPF 26. The upstream pressure sensor 27 detects the pressure of the exhaust gas upstream of the GPF 26. The downstream pressure sensor 28 detects the pressure of the exhaust gas downstream of the GPF 26.

The ECU 30 functions as a pressure difference detector. The ECU 30 includes an arithmetic device such as a central processing unit (CPU) and a storage device such as a random access memory (RAM) and a read only memory (ROM). The ECU 30 performs various controls by executing programs stored in the ROM or the storage device. The ECU 30 functions as an upstream pressure detection value acquiring unit 31, a processed upstream pressure value acquiring unit 32, a downstream pressure detection value acquiring unit 33, a processed downstream pressure value acquiring unit 34, a processed differential pressure value acquiring unit 35, an intake air amount correcting unit 36, and an actual differential pressure acquiring unit 37.

The upstream pressure detection value acquiring unit 31 acquires the upstream pressure detection value detected by the upstream pressure sensor 27. The processed upstream pressure value acquiring unit 32 acquires a processed upstream pressure value acquired by performing a process of passing the upstream pressure detection value through a low-pass filter (LPF) 32a. The downstream pressure detection value acquiring unit 33 acquires the downstream pressure detection value detected by the downstream pressure sensor 28. The processed downstream pressure value acquiring unit 34 acquires a processed downstream pressure value acquired by performing a process of passing the downstream pressure detection value through a LPF 34a. The processed differential pressure value acquiring unit 35 acquires a processed differential pressure value which is a difference between the processed upstream pressure value and the processed downstream pressure value. As a variation, as illustrated in FIG. 1B, a processed differential pressure value acquiring unit 54 may be employed instead of the processed differential pressure value acquiring unit 35. variations will be described later. In the present embodiment, the cutoff frequencies of the LPF 32a and 34a are set to 1Hz, but this is merely an example, and other frequencies may be used.

The intake air amount correcting unit 36 performs a smoothing process on the actual intake air amount acquired by the air flow meter 20, the smoothing process corresponding to a response delay that occurs in the processed upstream pressure value due to the process performed by the LPF 32a. The smoothing process may be performed to correspond to a response delay that occurs in the processed downstream pressure value due to the process by the LPF 34a. The actual differential pressure acquiring unit 37 acquires the processed differential pressure value corresponding to the corrected intake air amount as the actual differential pressure value. The intake air amount correcting unit 36 may perform a smoothing process, corresponding to a response delay that occurs in the processed downstream pressure value due to the process by the LPF 34a, on the actual intake air amount acquired by the air flow meter 20. In the present embodiment, the ECU 30 functions as the LPFs 32a and 34a, but the LPFs 32a and 34a may be configured as an electric circuit in which a resistor, a capacitor, and the like are combined.

The air flow meter 20, the upstream pressure sensor 27, the downstream pressure sensor 28, and the ECU 30 are included in the pressure difference detection device according to the present embodiment.

### Principle of Detecting Pressure Difference and Detection Policy

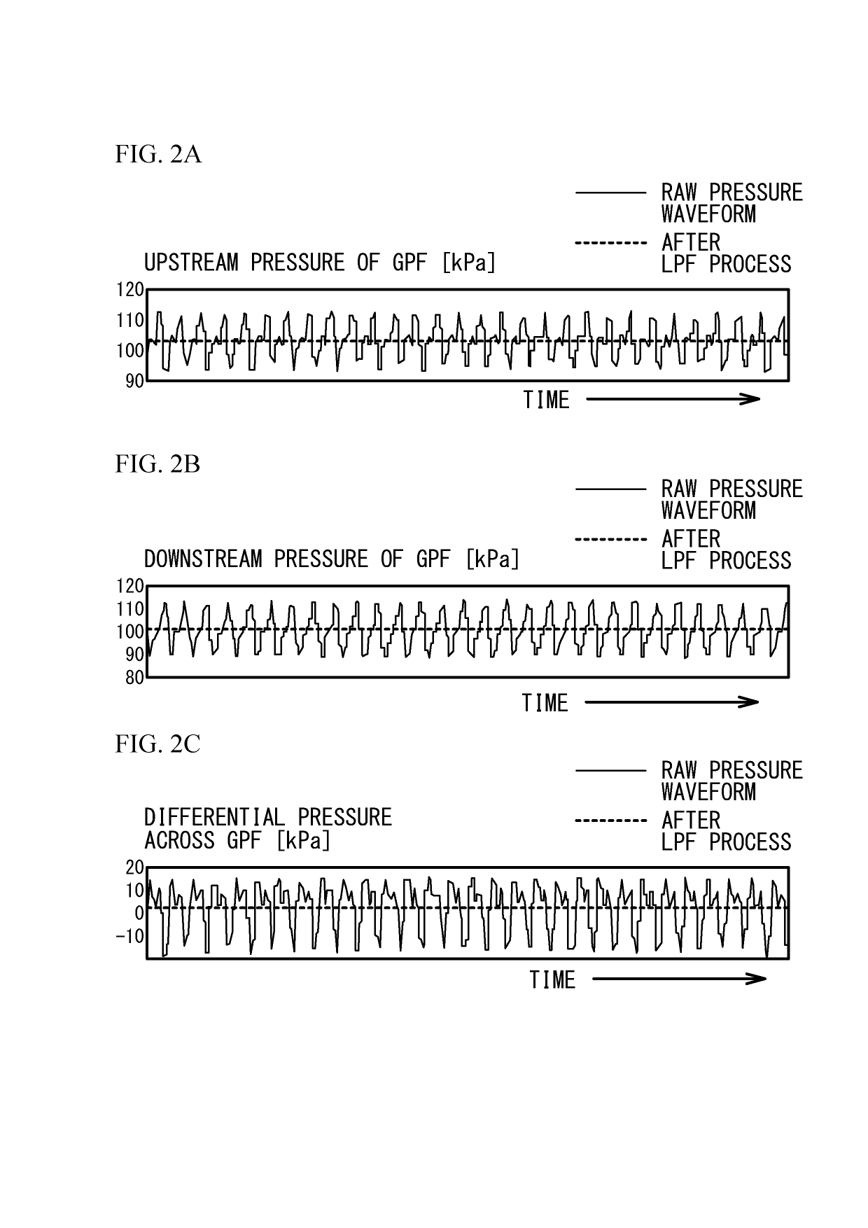

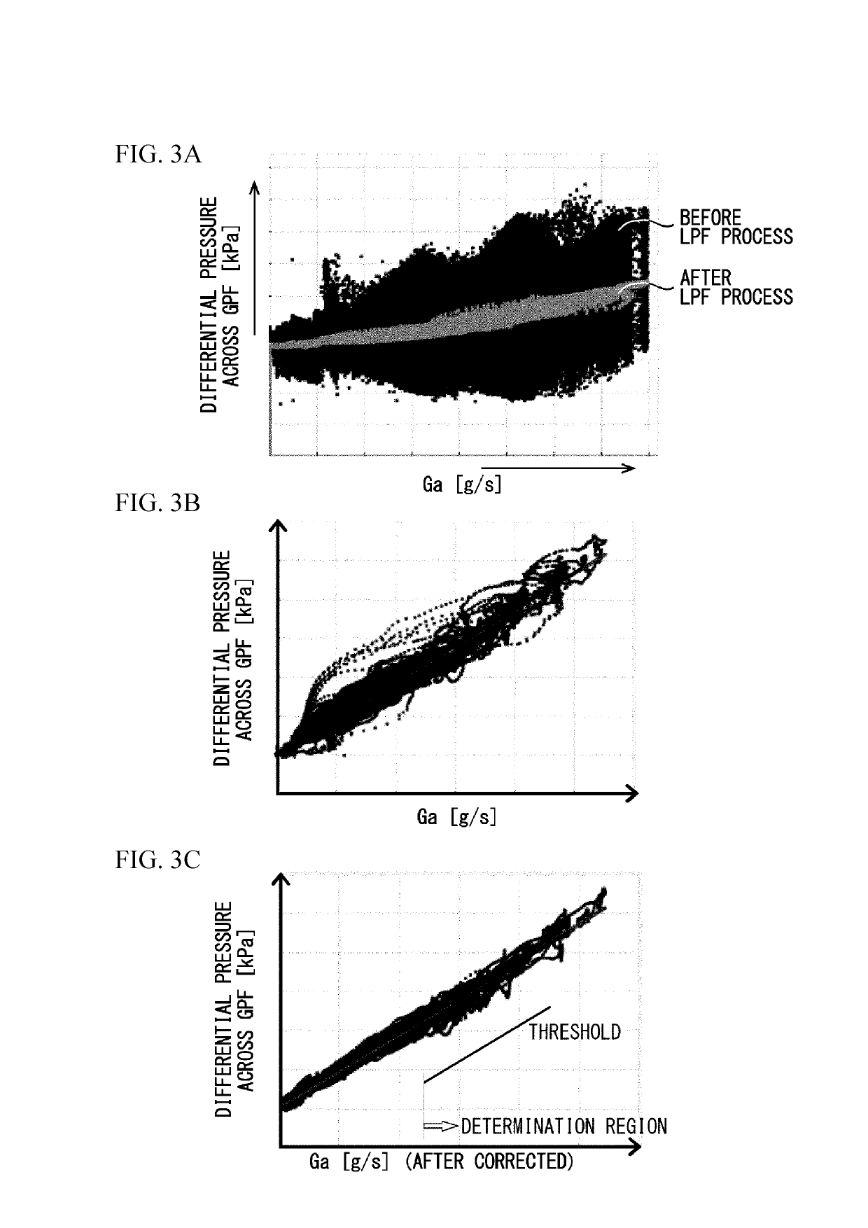

Next, the principle and principle of pressure-detection will be described with reference to FIGS. 2 to 3C.

In FIG. 2A, the raw detected value of the upstream air pressure of the GPF 26, that is, the raw pressure waveform of the detected value of the upstream air pressure is drawn by a solid line. In FIG. 2A, the waveform of the upstream pressure detection value after the LPF process, that is, the processed upstream pressure value, is drawn by a dotted line.

In FIG. 2B, the raw detected value of the downstream pressures of the GPF 26, that is, the raw pressure waveform of the detected value of the downstream pressures is drawn by a solid line. In FIG. 2B, the waveform of the downstream pressure detection value after the LPF process, that is, the processed downstream pressure value, is drawn by a dotted line.

FIG. 2C, the differential pressure between the upstream pressure detection value and the downstream pressure detection value, that is, the raw pressure waveform of the differential pressure detection value is drawn by a solid line. In FIG. 2C, the waveform of the differential pressure detection value after the LPF process, that is, the processed differential pressure value, is drawn by a dotted line.

Referring to FIG. 2A, in the waveform of the processed upstream pressure value, the pulsation amplitude in the raw waveform of the upstream pressure detection value is reduced. Referring to FIG. 2B, in the waveform of the processed downstream pressure value, the pulsation amplitude in the raw pressure waveform. Further, referring to FIG. 2C, the pulsation amplitude in the raw pressure waveform is also reduced in the waveform of the processed differential pressure value. Thus, the pulsation amplitude is reduced, and thus it is possible to suppress the occurrence of the aliasing phenomenon.

Next, referring to FIG. 3A, the relationship between the intake air amount Ga and the differential pressure across the particulate collection filter before the LPF process is illustrated. In FIG. 3A, a plot distribution region (region indicated by black) indicated as "before LPF process" spreads over a wide range of the differential pressure across the GPF. In the plot distribution region before the LPF process, the differential pressure across the GPF tends to increase with an increase in the intake air amount Ga. In contrast, in the plot distribution region (region indicated by gray) indicated as "after LPF process", the distribution range of the differential pressure across the GPF is reduced as compared with the plot distribution region before LPF process. This is related to the fact that the pulsation amplitude of the processed differential pressure value is reduced as illustrated in FIG. 2C. Thus, it is confirmed that even if the pulsation amplitude of the processed differential pressure value after the LPF process is reduced, the tendency that the differential pressure across the GPF increases with the increase in the intake air amount Ga is maintained.

Next, referring to FIG. 3B, the relationship between the intake air amount Ga and the differential pressure across the GPF after the LPF process is illustrated in an enlarged manner. According to FIG. 3B, variation is observed in the distribution range of the differential pressure across the GPF. That is, some plots are out of the upward sloping band-like region. This is considered to be caused by the fact that the GPF differential pressure is subjected to the LPF process. That is, the processed upstream pressure value and the processed downstream pressure detection value for acquiring the processed differential pressure value have a response delay due to the LPF process. In contrast, the intake air amount Ga is not processed. This influence is considered to appear as a variation in the distribution range of the differential pressure across the GPF. Therefore, in the present embodiment, the corrected intake air amount is acquired by performing a smoothing process on the actual intake air amount in accordance with the response delay occurring in the processed upstream pressure value and the processed downstream pressure detection value.

Referring to FIG. 3C, the distribution range of the differential pressure across the GPF is within a band-shaped region that is substantially inclined upward to the right. In this way, by adopting the corrected intake air amount, it is possible to acquire an appropriate correspondence relationship between the GPF differential pressure and the intake air amount Ga. The actual differential pressure value is acquired based on the relationship between the GPF differential pressure and the intake air amount Ga illustrated in FIG. 3C.

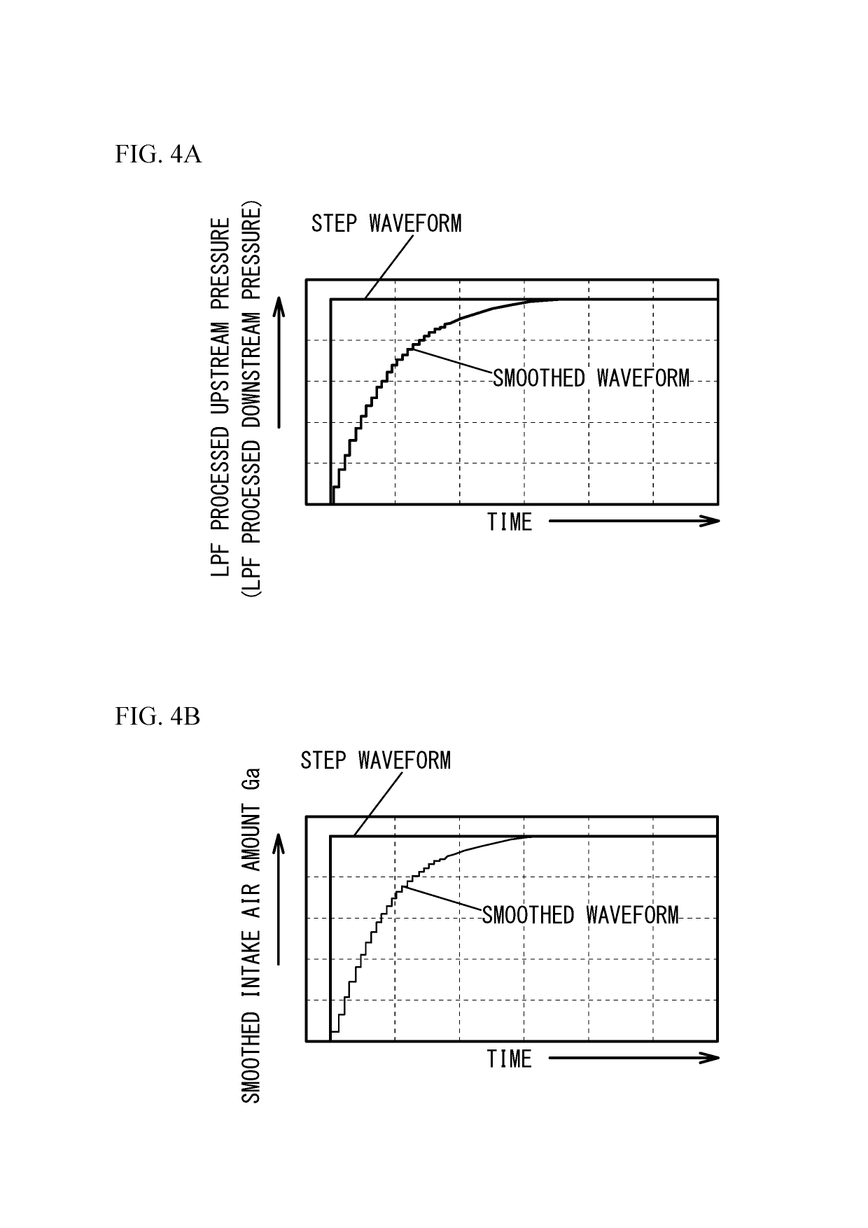

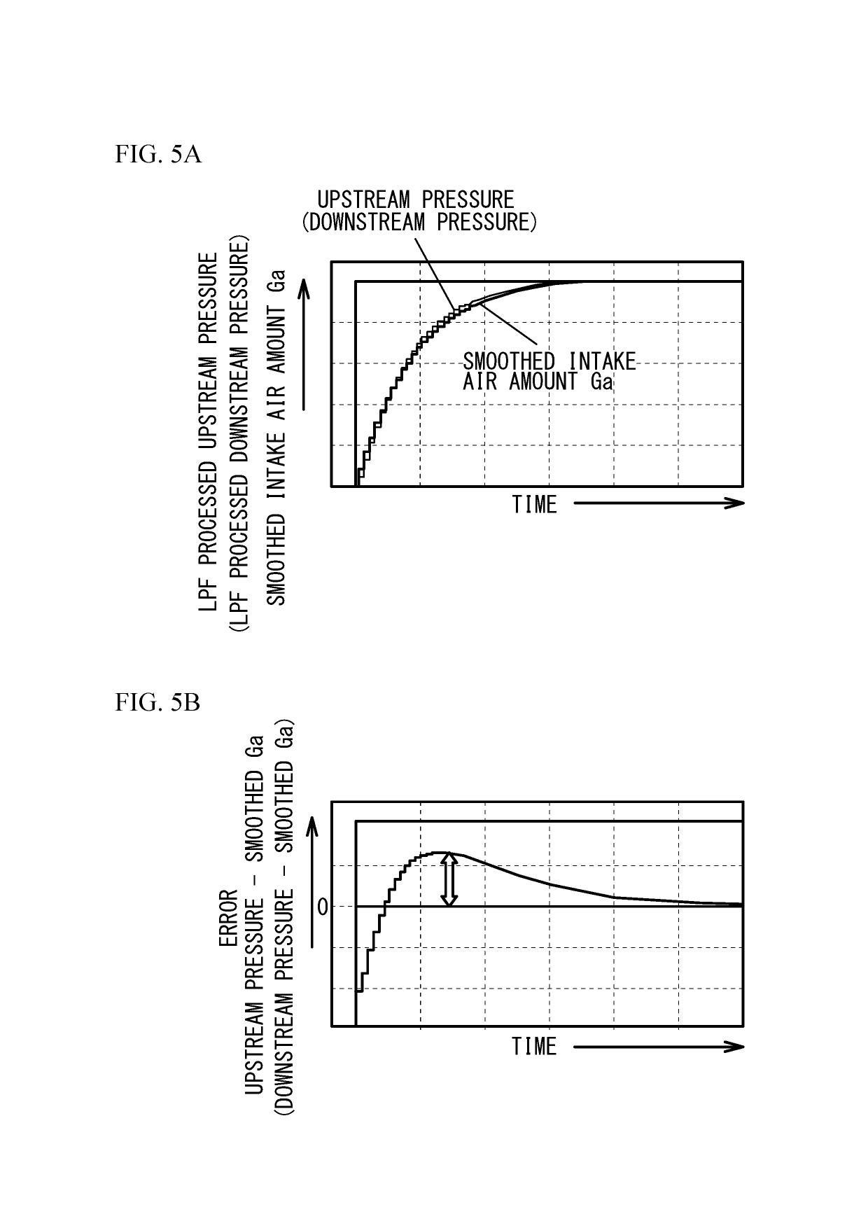

Here, an example of the smoothing process on the intake air amount in the present embodiment will be described with reference to FIGS. 4A to 5B. In the present embodiment, the response delay caused by the GPF process of the upstream pressure detection value and the downstream pressure detection value is reproduced by the simulation using the model. The number of times of smoothing the intake air amount is set so as to correspond to the response delay.

Although FIG. 4A illustrates a model in which the LPF process is performed on the upstream pressure detection value, the downstream pressure detection value may be subjected to the LPF process instead of the upstream pressure detection value. Further, the differential pressure value acquired by subtracting the downstream pressure detection value from the upstream pressure detection value may be subjected to the LPF process. In the following description, it is assumed that the LPF process is performed on the upstream pressure detection value. FIG. 4A illustrates a model in which information corresponding to the upstream pressure detection value is given in the form of a step waveform, and the step waveform is subjected to the LPF process to acquire a smoothed waveform with the response delay. The cutoff frequencies of the LPFs are set to 1Hz. The cutoff frequencies are not limited to 1Hz, and may be other frequencies. In FIG. 4B, information corresponding to the intake air amount is given in the form of a step waveform, similarly to the step waveform given in FIG. 4A, and the step waveform is subjected to a plurality of smoothing processes. In FIG. 5A, the smoothed waveform illustrated in FIG. 4A and the smoothed waveform illustrated in FIG. 4B are illustrated in an overlaid manner. FIG. 5B illustrates errors between the upstream air pressure value after the LPF process, that is, the processed upstream air pressure value, and the intake air amount after the smoothing process. The number of times of smoothing the intake air amount is set to the number of times at which the absolute value of the error becomes minimum. By performing the smoothing process a plurality of times, the difference between the processed upstream pressure value and the intake air amount after the process, that is, the corrected intake air amount, is reduced. As a result, the waveform indicating the change in the intake air amount gradually matches the waveform of the processed differential pressure value with a response delay. The set number of smoothing times is stored in the ECU 30. The stored number of smoothing times is used for pressure difference detection control executed by the ECU 30.

The smoothing process described here is an example, and smoothing process to which various known methods are applied may be performed. The number of smoothing times may be set by calculation by the ECU 30.

### Pressure Difference Detection Control

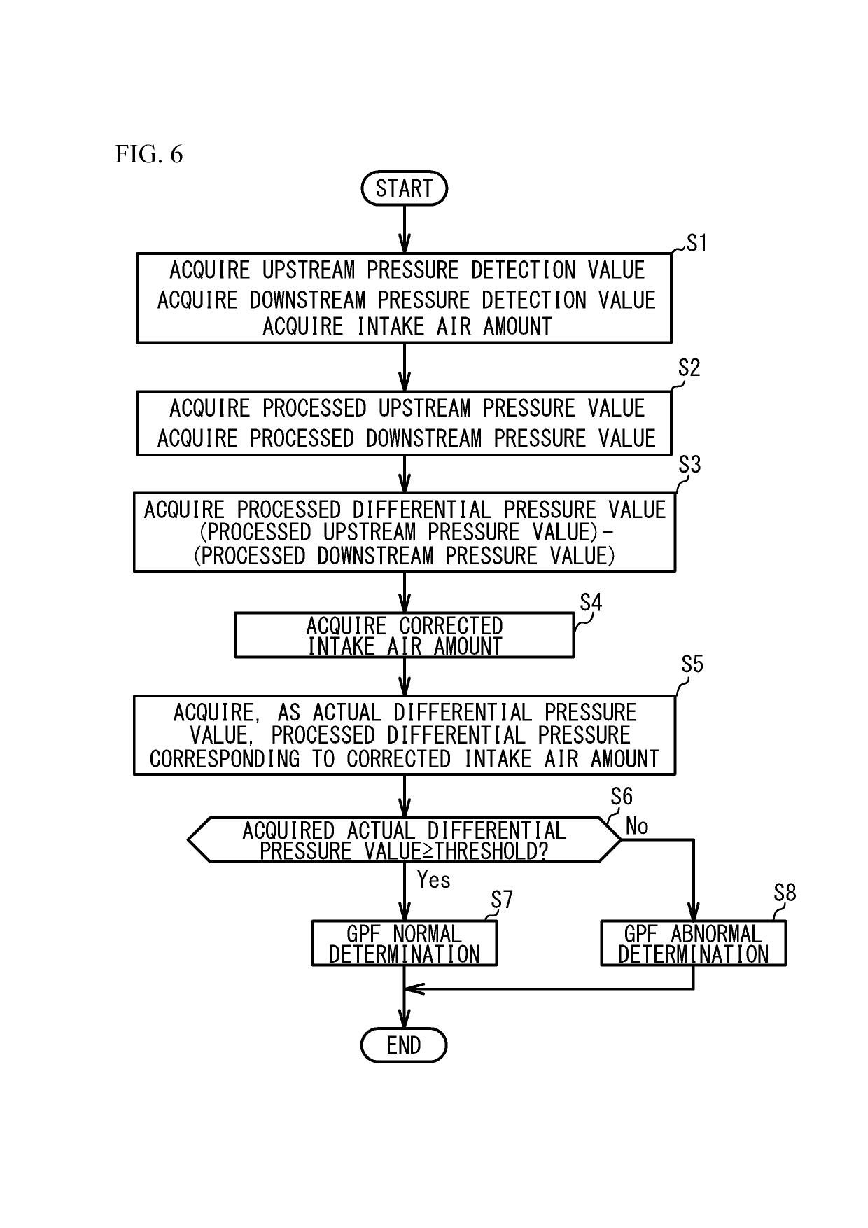

Next, an example of the detection control of the difference pressure across the GPF 26 will be described with reference to FIG. 6.

In step S1, the upstream pressure detection value acquiring unit 31 acquires the upstream pressure detection value detected by the upstream pressure sensor 27. The downstream pressure detection value acquiring unit 33 acquires the downstream pressure detection value detected by the downstream pressure sensor 28. The intake air amount correcting unit 36 acquires the value of the actual intake air amount acquired by the air flow meter 20. After step S1, the process proceeds to step S2.

In step S2, the processed upstream pressure value acquiring unit 32 passes the upstream pressure detection value through the LPF 32a to acquire a processed upstream pressure value. The processed downstream pressure value acquiring unit 34 acquires a processed downstream pressure value by passing the downstream pressure detection value through the LPF 34a. After step S2, the process proceeds to step S3. The processed upstream pressure value that has passed through the LPF 32a and the processed downstream pressure value that has passed through the LPF 34a have reduced pulsation amplitudes, and therefore, the occurrence of the aliasing phenomenon is suppressed.

In step S3, the processed differential pressure value acquiring unit 35 acquires the processed differential pressure value which is the difference between the processed upstream and downstream pressures. After step S3, the process proceeds to step S4.

In step S4, the intake air amount correcting unit 36 performs the smoothing process on the actual intake air amount a preset number of times to acquire a corrected intake air amount. After step S4, the process proceeds to step S5. The process of step S4 may be performed simultaneously with or prior to the processes of steps S2 and S3. In short, step S4 has only to be completed before proceeding to step S5.

In step S5, the actual differential pressure acquiring unit 37 acquires, as an actual differential pressure value, a value corresponding to the corrected intake air amount acquired in step S3, from the processed differential pressure acquired in step S4. The discrepancy between the processed differential pressure and the corrected intake air amount due to the response delay is eliminated. Therefore, an accurate actual differential pressure value is acquired. The actual differential pressure value may be acquired in step S5 when the actual intake air amount or the corrected intake air amount is equal to or larger than a predetermined value. This is because the actual differential pressure value increases as the intake air amount increases, and it becomes easy to acquire an accurate actual differential pressure value. That is, when the actual differential pressure value is acquired in a small region, the ratio of the error to the actual differential pressure value is considered to increase. Therefore, by acquiring the actual differential pressure value when the actual intake air amount or the corrected intake air amount is equal to or larger than the predetermined value, a more accurate actual differential pressure value is acquired.

The actual differential pressure value between the upstream and downstream pressures of the GPF 26 is acquired by the process up to step S5. The ECU 30 in the present embodiment determines whether the GPF 26 is normal or not based on the acquired actual differential pressure value. Therefore, in the present embodiment, after step S5, the process proceeds to step S6.

In step S6, the ECU 30 determines whether the acquired actual differential pressure value is equal to or greater than a predetermined value. The thresholds are set in advance based on simulation or experiment. When the determination result in step S6 is positive (Yes), the ECU 30 proceeds to step S7. In step S7, the ECU 30 determines whether the GPF 26 is normal. Thus, a series of processes is completed. On the other hand, when a negative determination (No determination) is made in step S6, the process proceeds to step S8. In step S8, the ECU 30 determines the abnormality of the GPF 26. Thus, a series of processes is completed. The acquired actual differential pressure value may be used for other purposes such as determination whether the GPF 26 regeneration process is required.

### Variation

Next, a variation will be described. In the variation, an ECU 50 is employed instead of the ECU 30. In FIG. 1B, a functional block view of the ECU 50 is illustrated. The ECU 50 functions as a differential pressure detection value acquiring unit 51. The differential pressure detection value acquiring unit 51 includes an upstream pressure detection value acquiring unit 52 and a downstream pressure detection value acquiring unit 53. The ECU 50 functions as the processed differential pressure value acquiring unit 54, an intake air amount correcting unit 55, and an actual differential pressure acquiring unit 56.

The upstream pressure detection value acquiring unit 52 acquires the upstream pressure detection value detected by the upstream pressure sensor 27. The downstream pressure detection value acquiring unit 53 acquires the downstream pressure detection value detected by the downstream pressure sensor 28. The differential pressure detection value acquiring unit 51 acquires a differential pressure detection value which is a difference between the upstream pressure detection value and the downstream pressure detection value. The processed differential pressure value acquiring unit 54 acquires a processed differential pressure value acquired by passing the differential pressure detection value through an LPF 54a. The intake air amount correcting unit 55 performs a smoothing process on the actual intake air amount acquired by the air flow meter 20, the smoothing process corresponding to a response delay that occurs in the processed differential pressure value due to the process performed by the LPF 54a. The actual differential pressure acquiring unit 56 acquires the processed differential pressure value corresponding to the corrected intake air amount as the actual differential pressure value.

That is, in the embodiment, the LPF process is performed on each of the upstream pressure detection value and the downstream pressure detection value before the differential pressure across the GPF 26 is acquired, and then the processed differential pressure value is acquired by acquiring the difference between the values. In contrast, in the variation, the differential pressure detection value, which is the difference between the upstream pressure detection value and the downstream pressure detection value, is acquired, and the processed differential pressure value is acquired by performing the LPF process on the differential pressure detection value. Even in such a form, the pressure difference is detected with high accuracy.

According to the present embodiment, the pressure difference detection is performed using the processed differential pressure value processed by the LPF. Since the processed differential pressure value has a reduced pulsation amplitude, the occurrence of the aliasing phenomenon is suppressed. In the present embodiment, the pressure difference is detected using the corrected intake air amount that has been subjected to the smoothing process corresponding to the response delay that has occurred in the value to be processed due to the process by the LPF. Therefore, the pressure difference is detected with high accuracy.

Although some embodiments of the present disclosure have been described in detail, the present disclosure is not limited to the specific embodiments but may be varied or changed within the scope of the present disclosure as claimed.

What is claimed is:

1. A pressure difference detection device, for a particulate collection filter, comprising:
an upstream pressure sensor that is disposed on an upstream side of the particulate collection filter disposed in an exhaust path connected to an internal combustion engine and detects an upstream pressure of the particulate collection filter;
a downstream pressure sensor that is disposed on a downstream side of the particulate collection filter and detects a downstream pressure of the particulate collection filter;
an air flow meter that is disposed in an intake path connected to the internal combustion engine and detects an intake air amount;
a low-pass filter configured to reduce a high-frequency component included in each of an output signal of the upstream pressure sensor and an output signal of the downstream pressure sensor so as to reduce pulsation amplitude;
a processed differential pressure value acquiring unit configured to acquire a processed differential pressure value which is a difference between a processed upstream pressure value and a processed downstream pressure value, the processed upstream pressure value being the output signal of the upstream pressure sensor after passing through the low-pass filter, the processed downstream pressure value being the output signal of the downstream pressure sensor after passing through the low-pass filter;
an intake air amount correcting unit configured to perform a smoothing process on the intake air amount detected by the air flow meter to acquire a corrected intake air amount, such that the corrected intake air amount follows a change rate of the processed differential pressure value in which a response delay is reflected, the response delay being caused by passing the output signal of the upstream pressure sensor and the output signal of the downstream pressure sensor through the low-pass filter are reflected in the change rate; and
an actual differential pressure value acquiring unit configured to acquire an actual differential pressure value between an upstream pressure and a downstream pressure of the particulate collection filter based on a correspondence relationship between the processed differential pressure value and the corrected intake air amount.

2. The pressure difference detection device for the particulate collection filter according to claim 1, wherein the smoothing process is performed such that a waveform indicating a change in the intake air amount approaches a waveform of the processed differential pressure value in which the response delay occurs.

3. The pressure difference detection device for the particulate collection filter according to claim 2, wherein the intake air amount correcting unit is configured to perform the smoothing process so as to match the waveform indicating a change in the intake air amount with the waveform of the processed differential pressure value in which the response delay occurs.

4. The pressure difference detection device for the particulate collection filter according to claim 1,
wherein
the output signal of the upstream pressure sensor and the output signal of the downstream pressure sensor are input to the low-pass filter, and
the low-pass filter is configured to reduce high-frequency components respectively included in the output signal of the upstream pressure sensor and the output signal of the downstream pressure sensor so as to reduce the pulsation amplitude.

5. The pressure difference detection device for the particulate collection filter according to claim 1,
wherein
a difference value between the output signal of the upstream pressure sensor and the output signal of the downstream pressure sensor is input to the low-pass filter, and
the low-pass filter is configured to reduce a high-frequency component included in the difference value so as to reduce the pulsation amplitude.
